(19) United States
(12) Patent Application Publication
(10) Pub. No.: US 2019/0369825 A1
(43) Pub. Date: Dec. 5, 2019

(54) ELECTRONIC DEVICE AND METHOD FOR PROVIDING INFORMATION RELATED TO IMAGE TO APPLICATION THROUGH INPUT UNIT

(71) Applicant: Samsung Electronics Co., Ltd., Gyeonggi-do (KR)

(72) Inventors: Seunghwan JEONG, Gyeonggi-do (KR); Dasom LEE, Gyeonggi-do (KR); Changwon KIM, Gyeonggi-do (KR); Hyunjin KIM, Gyeonggi-do (KR); Imkyeong YOU, Gyeonggi-do (KR); Kihuk LEE, Gyeonggi-do (KR)

(21) Appl. No.: 16/429,393

(22) Filed: Jun. 3, 2019

(30) Foreign Application Priority Data
Jun. 5, 2018 (KR) 10-2018-0064892

(51) Int. Cl. G06F 3/0484; G06F 17/27; G06F 3/0488; G06K 9/62; G06F 16/54; G06F 16/532

(52) U.S. Cl. CPC G06F 3/0484; G06F 17/2705; G06F 16/532; G06K 9/6253; G06F 16/54; G06F 3/04886

(57) ABSTRACT

Disclosed is an electronic device including: a memory; a display; and a processor, wherein the processor is configured to display an input unit capable of receiving a user input performed on an application being executed by the electronic device on the display, identify one or more images stored in the memory or an external electronic device, based at least on the displaying, display at least some of the one or more images in association with the input unit, acquire recognition information generated by recognizing at least a portion of content included in an image selected according to a designated input among at least some images, acquire character information corresponding to the recognition information, based at least on the acquisition, and provide the character information to the application as at least a portion of the user input through the input unit.

### CROSS-REFERENCE TO RELATED APPLICATION(S)

This application is based on and claims priority under 35 U.S.C. 119 to Korean Patent Application No. 10-2018-0064892, filed on Jun. 5, 2018, in the Korean Intellectual Property Office, the disclosure of which is herein incorporated by reference in its entirety.

### BACKGROUND

### 1) Field

The disclosure relates to an electronic device for providing a virtual keyboard (for example, an input unit) for information retrieval on the basis of an image and a method thereof.

### 2) Description of Related Art

With the development of various technologies, electronic devices for providing a more intuitive information retrieval service is desirable. For example, electronic devices performing information retrieval using an image rather than text may be more user-friendly.

The above information is presented as background information only to assist with an understanding of the disclosure. No determination has been made, and no assertion is made, as to whether any of the above might be applicable as prior art with regard to the disclosure.

### SUMMARY

In accordance with an aspect of the disclosure, an electronic device comprises a memory, a display, and at least one processor, wherein the at least one processor is configured to display an input unit capable of receiving a user input to an application being executed by the electronic device on the display, identify one or more images stored in the memory or an external electronic device, the one or more images related to the application, display some of the one or more images in association with the input unit, recognize at least a portion of content included in a selected image among thesome of the one or more images, provide character information to the application based on the recognized at least the portion of the content as a portion of the user input through the input unit. In accordance with another aspect of the disclosure, an electronic device is provided.

The electronic device comprises a memory storing instructions, a display, and at least one processor, wherein the at least one processor is configured to, when executing the instructions display a user interface of an application, display a designated object and a plurality of keys indicating a plurality of characters within a display area of a virtual keyboard, at least a portion of which is superimposed on a user interface in response to identification of an input performed on a text-input portion included in the user interface, identify one or more images related to an application among a plurality of applications stored in the electronic device, based at least on identification of the input performed on the designated object, and display one or more thumbnail images for representing the one or more images within the display area of the virtual keyboard, wherein selection of a selected one of the one or more thumbnail images causes a query based on the selected one of the one or or more thumbnail images.

In accordance with another aspect of the disclosure, an electronic device is provided. The electronic device includes: a memory storing instructions; a display; and at least one processor, wherein the at least one processor is configured to display a first thumbnail image for representing a first image among a plurality of images stored in the electronic device along with a first user interface, based on reception of input performed on a designated object included in a virtual keyboard for at least a portion of a time during which the virtual keyboard is displayed along with the first user interface of a first application, provide content retrieved based at least on the first image within the first user interface, based on reception of at least one input performed on the first thumbnail image, display a second thumbnail image for representing a second image distinct from the first image among the plurality of images along with a second user interface, based on reception of the input performed on the designated object included in the virtual keyboard for the at least the portion of the time during which the virtual keyboard is displayed along with the second user interface of a second application, distinct from the first application, and provide other content distinct from the content retrieved based at least on the second image within the second user interface, based on reception of at least one input performed on the second thumbnail image.

The technical subjects pursued in the disclosure are not limited to the above mentioned technical subjects, and other technical subjects which are not mentioned may be clearly understood through the following descriptions by those skilled in the art of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device within a network environment according to certain embodiments;

FIG. 2A is a block diagram illustrating a program according to certain embodiments;

FIG. 2B illustrates an example of software used by a processor of an electronic device according to certain embodiments;

FIG. 3A illustrates an example of operation of an electronic device according to certain embodiments;

FIG. 3B illustrates another example of operation of the electronic device according to certain embodiments;

FIG. 4 illustrates an example of a screen displayed in the electronic device according to certain embodiments;

FIG. 5A illustrates an example of the operation of the electronic device storing an image according to certain embodiments;

FIG. 5B illustrates an example of methods of acquiring the image by the electronic device according to certain embodiments;

FIG. 5C illustrates an example of methods of generating relevant information of the image acquired by the electronic device according to certain embodiments;

FIG. 5D illustrates an example of a method of storing relevant information of the image acquired by the electronic device according to certain embodiments;

FIG. 5E illustrates another example of a method of storing relevant information of the image acquired by the electronic device according to certain embodiments;

FIG. 6 illustrates an example of the operation of the electronic device providing an image-based retrieval service through a virtual keyboard according to certain embodiments;

FIG. 7A illustrates an example of the operation of the electronic device acquiring at least one piece of text according to certain embodiments;

FIG. 7B illustrates another example of the operation of the electronic device acquiring at least one piece of text according to certain embodiments;

FIG. 7C illustrates an example of a method of displaying at least one piece of text by the electronic device according to certain embodiments;

FIG. 7D illustrates an example of a screen displayed in the electronic device according to certain embodiments;

FIG. 8A illustrates an example of the operation of the electronic device storing retrieved multimedia content in association with an image according to certain embodiments;

FIG. 8B illustrates an example of a method of storing information associated with an image acquired by the electronic device according to certain embodiments;

FIG. 9A illustrates another example of the operation of the electronic device according to certain embodiments;

FIG. 9B illustrates an example of a screen of the electronic device providing different thumbnail images depending on the type of application provided along with a virtual keyboard according to certain embodiments;

FIG. 10A illustrates an example of the operation of the electronic device displaying a designated object along with a plurality of keys according to certain embodiments; and

FIG. 10B illustrates an example of a method of configuring a visual keyboard function according to certain embodiments.

### DETAILED DESCRIPTION

When an electronic device provides an image retrieval service through a dedicated application (for example, Bixby vision) or an image retrieval function within a specific application, the image retrieval service area should not be limited within the dedicated application or the specific application. Accordingly, it may be allowable to allow image retrieval independently from an application or a service.

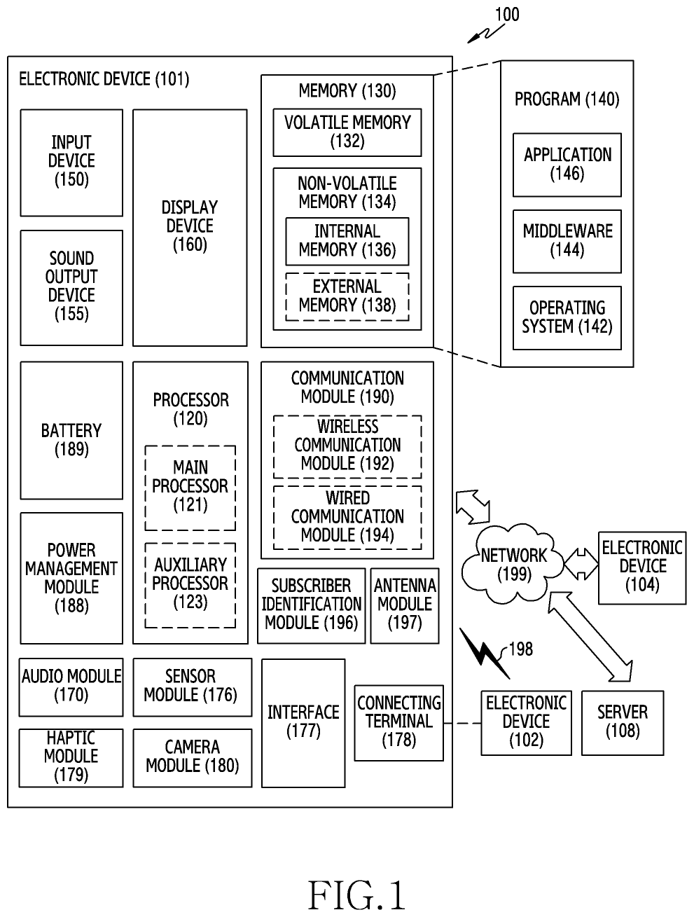

FIG. 1 is a block diagram illustrating an electronic device 101 in a network environment 100 according to certain embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

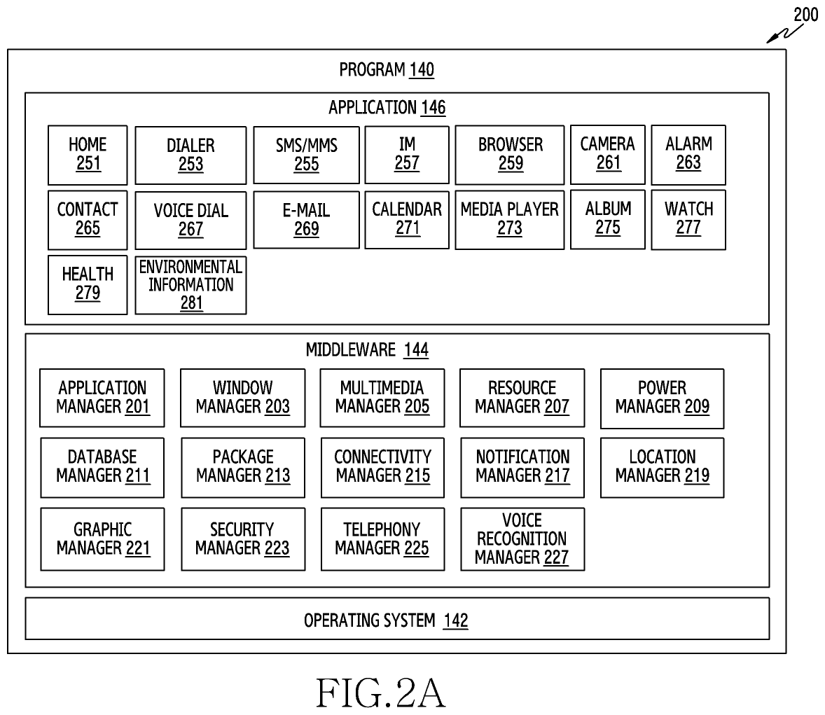

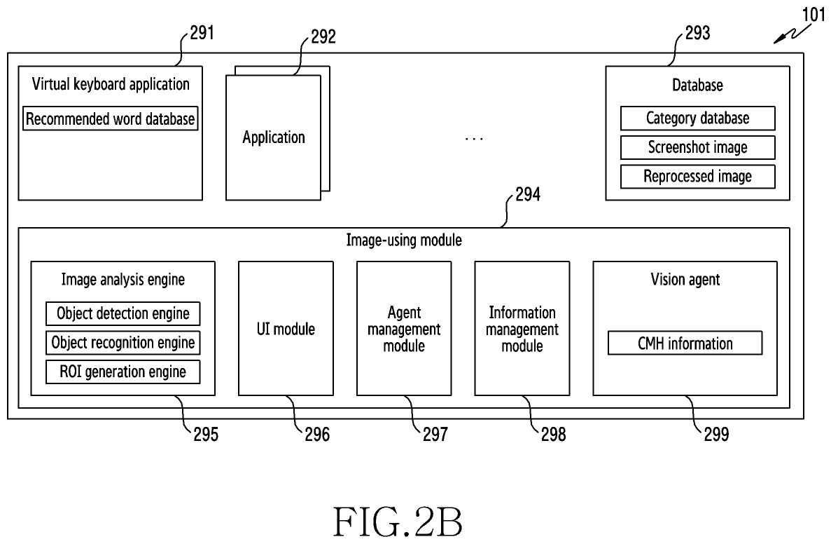

FIG. 2A is a block diagram 200 illustrating the program 140 according to certain embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

The electronic device according to certain embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

FIG. 2B illustrates an example of memory storing software used by a processor of an electronic device according to certain embodiments. The software may be used by the processor 120 included in the electronic device 101 illustrated in FIG. 1.

Referring to FIG. 2B, the electronic device 101 may include memory storing a virtual keyboard application 291 used by the processor 120, a plurality of applications 292 distinct from the virtual keyboard application 291, a database 293, and an image-using module 294. According to certain embodiments, the virtual keyboard application 291, the plurality of applications 292, the database 293, and the image-using module 294 may be stored in the memory 130.

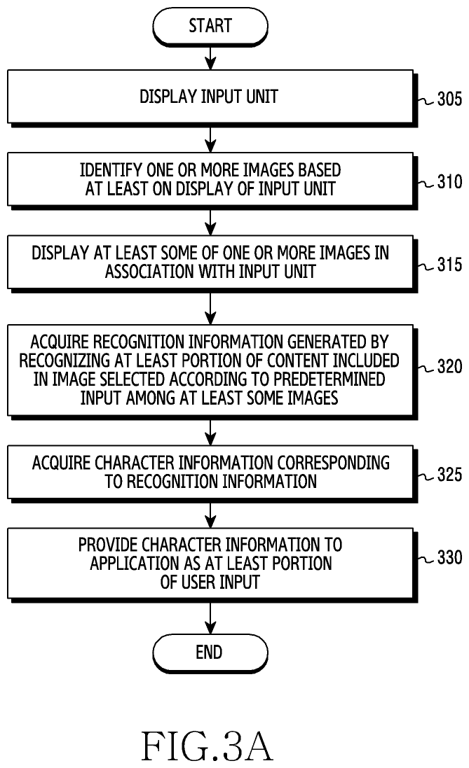

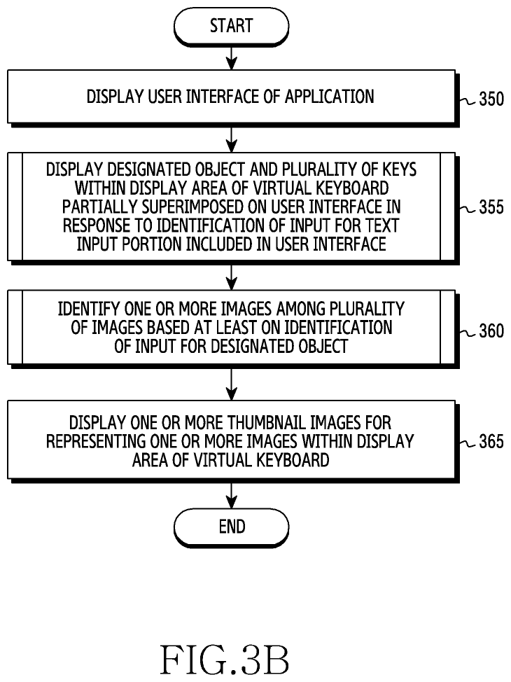

According to certain embodiments, the virtual keyboard application 291 may provide a virtual keyboard along with a user interface of each of the plurality of applications 292. The virtual keyboard may include a plurality of keys indicating a plurality of characters and a predetermined object for providing an image-based retrieval service through the virtual keyboard. The virtual keyboard application 291 may interwork with a recommended word database stored in the memory 130. The recommended word database may provide a predicted word (or text) when using the virtual keyboard application 291. According to certain embodiments, the word may include text related to the image-based retrieval service described with reference to the drawings from FIG. 3A.

According to certain embodiments, each of the plurality of applications 292 may be an application providing the image-based retrieval service using the virtual keyboard within a user interface. For example, when an application providing a movie-streaming service that includes video frames, the application may interwork with the virtual keyboard application 291 to provide the image-based retrieval service through an image from a frame of the video frames. In another example, when an application 292 is provides a music-streaming, the application 292 may interwork with the virtual keyboard application 291 to provide the image-based retrieval through an image related to music. However, this disclosure is not limited to the foregoing.

According to certain embodiments, the database 293 may be used to store resources for providing the image-based retrieval service through interworking between the virtual keyboard application 291 and each of the plurality of applications 292. For example, the database 293 may include at least one of a screenshot image, a re-processed image including associated information (described below) mapped to the screenshot image, and a category database for classifying the screenshot image and the re-processed image.

According to certain embodiments, the image-using module 294 may include an image analysis engine 295, a User Interface (UI) module 296, an agent management module 297, an information management module 298, and a vision agent 299.

According to certain embodiments, the image analysis engine 295 may include an object detection engine, an object recognition engine, and a Range of Interest (ROI) generation engine. The image analysis engine 295 may analyze an acquired image through at least one of the object detection engine, the object recognition engine, and the ROI generation engine and process the image on the basis of analyzed information (for example, feature points of the object within the image and keywords (parameters) related to the image).

According to certain embodiments, the image analysis engine 295 may receive user feedback during a procedure of processing the image. For example, the image analysis engine 295 may recognize that an area designated by a stylus (or a finger-drag gesture) is a range of interest of the image on the basis of identification of the area designated by the stylus. In another example, the image analysis engine 295 may modify the acquired ROI without any user input (or independently from user input) on the basis of the user feedback.

According to certain embodiments, the image analysis engine 295 may interwork with a server (for example, the server 108) connected to the electronic device 101 in order to process the image. For example, the image analysis engine 295 may transmit information on an image stored in the memory 130 to the server and receive information on the ROI of the image from the server.

According to certain embodiments, the image analysis engine 295 may store the identified or acquired ROI in the memory 130.

According to certain embodiments, the UI module 296 may display a user interface for providing a service on the display device 160. For example, the UI module 296 may display a user interface for providing a processed image on the display device 160 and receive user feedback through the displayed user interface.

According to certain embodiments, the agent management module 297 may identify whether a query message should be transmitted in order to acquire information related to the image. For example, the agent management module 297 may identify whether a query message should be transmitted to the server in order to designate the ROI of the image. In another example, in order to acquire recognition information of an object acquired from the image, the agent management module 297 may identify whether information on the object should be transmitted to the server (for example, a server related to a webpage or a server related to an application installed in the electronic device 101).

According to certain embodiments, the information management module 298 may combine recognized information through the image analysis engine 295. According to certain embodiments, the information management module 298 may provide the combined information to at least some of the plurality of applications 292. The combined information may be provided to the server through at least some of the plurality of applications 292.

According to certain embodiments, the vision agent 299 may provide an image-based retrieval service, described below on the basis of Content Management Hub (CMH) information.

In another example, the CMH information may classify the result of analysis of content of the acquired image and store the classification result. For example, the CMH information may classify the acquired image as one category (for example, furniture) among categories of a first layer (human, furniture, cloth, and car) and then as one sub category among subcategories (for example, if the first layer is furniture, the sub-categories may include chair, desk, stand, and lamp) of the determined category of a second layer, lower than the first layer.

For example, the CMH information may store at least one of a color, atmosphere, scene, storage time point, and photographing location of the classified image in association with the classified image. Such association may be used for the image-based retrieval service described below.

According to certain embodiments, the vision agent 299 may be used to acquire an image from the outside, and may include instructions for operating a camera.

The software within the electronic device 101 illustrated in FIG. 2B may be used to implement operations of the electronic device 101 described below with reference to FIGS. 3A to 10B. According to the design of the electronic device 101 according to certain embodiments, at least some of the software within the electronic device 101 illustrated in FIG. 2B may be combined or omitted. Further, according to the design of the electronic device 101 according to certain embodiments, software other than the software within the electronic device 101 illustrated in FIG. 2B may be used by the electronic device 101.

As described above, an electronic device (for example, the electronic device 101) according to certain embodiments may include a memory (for example, the memory 130); a display (for example, the display 160); and a processor (for example, the processor 120), wherein the processor may be configured to display an input unit capable of receiving a user input performed on an application being executed by the electronic device on the display, identify one or more images stored in the memory or an external electronic device, based at least on the displaying, display at least some of the one or more images in association with the input unit, acquire recognition information generated by recognizing at least a portion of content included in an image selected according to a designated input among at least some images, acquire character information corresponding to the recognition information, based at least on the acquisition, and provide the character information to the application as at least a portion of the user input through the input unit.

According to certain embodiments, the processor may be configured to acquire context information related to the electronic device and determine at least some of the one or more images, based at least on the context information. According to some embodiments, the processor may be configured to identify other character information provided by the application through the input unit and store the other character information as at least a portion of attribute information of the selected image.

According to certain embodiments, the processor may be configured to store the other character information as at least the portion of the attribute information of the selected image by inserting the other character information into metadata on the selected image.

According to certain embodiments, the processor may be configured to acquire resultant information processed using the character information through the application and store the resultant information as at least a portion of attribute information of the selected image.

According to certain embodiments, the processor may be configured to transmit information on the image selected according to the designated input among at least some images to a server and acquire the recognition information on the content included in the image from the server.

According to certain embodiments, the processor may be configured to display the input unit, at least a portion of which is superimposed on the user interface of the application being executed by the electronic device and including a plurality of keys indicating a plurality of characters on the display and display at least some images switched from the plurality of keys within the input unit so as to display at least some images in association with the input unit.

As described above, an electronic device (for example, the electronic device 101) according to certain embodiments may include: a memory (for example, the memory 130) configured to store instructions; a display (for example, the display device 160); and at least one processor (for example, the processor 120), wherein the at least one processor is configured to, when executing the instructions, display a designated object and a plurality of keys indicating a plurality of characters within a display area of a virtual keyboard, at least a portion of which is superimposed on a user interface in response to identification of input performed on a text-input portion included in the user interface, identify one or more images related to an application among a plurality of applications stored in the electronic device, based at least on identification of the input performed on the designated object, and display one or more thumbnail images for representing the one or more images within the display area of the virtual keyboard, and the one or more thumbnail images are usable to provide a retrieval service within the user interface using the one or more images.

According to certain embodiments, the at least one processor may be further configured to, when executing the instructions, identify an input of selecting one thumbnail image among the one or more thumbnail images, display at least one piece of text acquired by recognizing an image represented by the selected thumbnail image along with the one or more thumbnail images, display the selected text within the text-input portion and display at least one piece of multimedia content related to the selected text within the user interface in response to identification of an input of selecting one text among the at least one text. For example, the at least one processor may be configured to, when executing the instructions, provide a function related to the selected piece of multimedia content through the user interface in response to identification of input of selecting one piece of multimedia content among the at least one piece of multimedia content and store at least one of the selected piece of multimedia content and the selected text in association with the image represented by the thumbnail image.

According to certain embodiments, the at least one processor may be configured to, when executing the instructions, identify one or more images associated with one or more services provided by the application among the plurality of images so as to identify the one or more images related to the application. For example, the at least one processor may be configured to, when executing the instructions, identify the one or more images associated with one or more services provided by the application among the plurality of images, based on information stored in the electronic device and associated with each of the plurality of images in response to identification of the input performed on the designated object, and the information associated with each of the plurality of images may include at least one piece of data acquired by recognizing content of each of the plurality of images, data on a source from which each of the plurality of images is acquired, and data on an application stored in the electronic device used to acquire each of the plurality of images, and may be stored in the electronic device in association with each of the plurality of images in response to acquisition of each of the plurality of images. For example, the information associated with each of the plurality of images may be included in each of the plurality of images. In another example, the information associated with each of the plurality of images may be configured with another file, distinct from an image file for each of the plurality of images, and the image and the other file may be configured as one dataset.

According to certain embodiments, the data on the source may include data on at least one webpage that the electronic device accesses during a time interval identified based on the time at which each of the plurality of images is acquired, and the at least one processor may be configured to, when executing the instructions, identify the one or more images associated with the one or more services provided by the application among the plurality of images, based on the data on the at least one webpage. For example, the data on the at least one webpage may be acquired by parsing a markup language file for the at least one webpage.

As described above, an electronic device (for example, the electronic device 101) according to certain embodiments may include: a memory (for example, the memory 130) configured to store instructions; a display (for example, the display device 160); and at least one processor (for example, the processor 120), wherein the at least one processor may be configured to display a first thumbnail image for representing a first image among a plurality of images stored in the electronic device along with a first user interface, based on reception of input performed on a designated object included in a virtual keyboard for at least a portion of a time during which the virtual keyboard is displayed along with the first user interface of a first application, provide content retrieved based at least on the first image within the first user interface, based on reception of at least one input performed on the first thumbnail image, display a second thumbnail image for representing a second image, distinct from the first image, among the plurality of images, along with a second user interface, based on reception of the input performed on the designated object included in the virtual keyboard for at least a portion of the time during which the virtual keyboard is displayed along with the second user interface of a second application, distinct from the first application, and provide another piece of content distinct from the content retrieved based at least on the second image within the second user interface, based on reception of at least one input performed on the second thumbnail image.

According to certain embodiments, the second application may provide another service distinct from a service provided by the first application, the first image may be associated with the service provided by the first application, and the second image may be associated with the service provided by the second application.

According to certain embodiments, the content may be stored in association with the first image and the other piece of content may be stored in association with the second image.

According to certain embodiments, the at least one processor may be further configured to, when executing the instructions, stop displaying a plurality of keys included in the virtual keyboard while the first thumbnail image is displayed and stop displaying the plurality of keys while the second thumbnail image is displayed.

FIG. 3A illustrates an example of operation of an electronic device according to certain embodiments. The operation may be performed by the electronic device 101 of FIG. 1, the electronic device 101 of FIG. 2B, or the processor 120 of the electronic device 101.

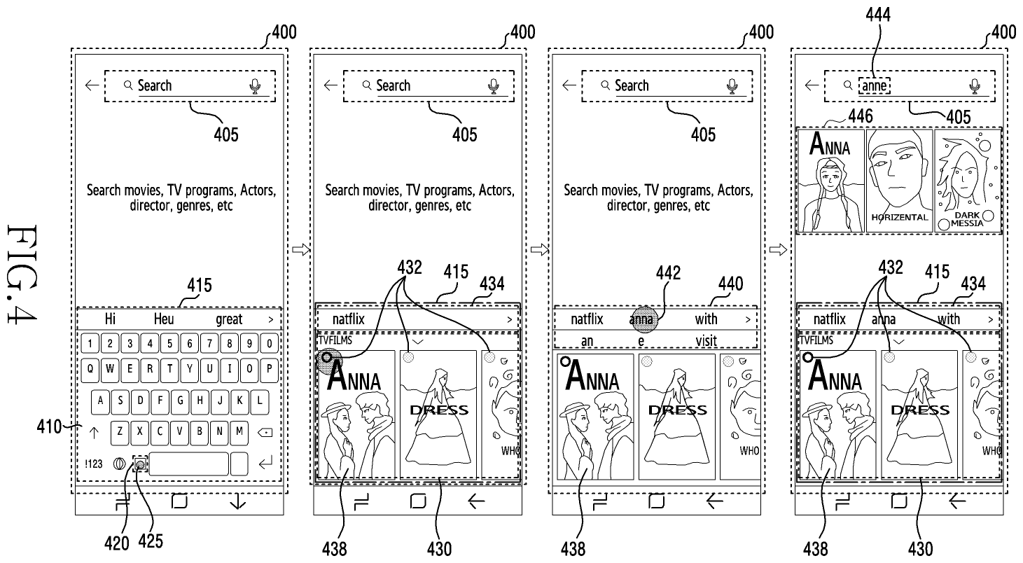

Referring to FIG. 3A, in operation 305, the processor 120 (or one or more processor(s), from hereinafter, usage of processor in the singular context shall be deemed to also include multiple processors) may display an input unit (for example, a virtual keyboard) capable of receiving a user input performed on an application being executed by the electronic device 101. In certain embodiments, this can include a virtual keyboard 410 in FIG. 4, (first screen drawing).

According to certain embodiments, the processor 120 may display the input unit along with a user interface of the application being executed. For example, the processor 120 may display the input unit, at least a portion of which is superimposed on the user interface of the application being executed. According to certain embodiments, the input unit may be displayed along with the user interface of the application on the basis of detection of generation of a specified or designated event while the application is executed or the user interface of the application is displayed. For example, the input unit may be displayed in response to reception of input performed on a text-input portion included in the user interface of the application. For example, the text-input portion may be used to input text (or characters) for executing a predetermined function in the application. In another example, the text-input portion may be used to provide a retrieval function in the application. For example, the input unit may include a virtual keyboard. According to certain embodiments, the retrieval function may be a function for retrieving at least one piece of data that is stored in the electronic device 101 and is related to the application or external data of the electronic device 101. However, this is not limiting. According to certain embodiments, the user input that can be received using the input unit may include a touch input on a touch panel of the electronic device 101. For example, the touch input may include one or more of a single-tap input on the touch panel, a multi-tap input on the touch panel, a drag input on the touch panel, a swipe input on the touch panel, and a depression input on the touch panel.

In operation 310, the processor 120 may identify one or more images stored in the memory 130 on the basis of at least the displaying of the input unit. According to certain embodiments, the processor 120 may identify the one or more images on the basis of detection of a specified or designated event (such as selection of enter/magnifying glass key in the virtual keyboard or an object in a GUI) while the input unit is displayed along with the user interface of the application. According to certain embodiments, the designated event may include reception of input performed on a designated object included in the input unit. For example, the designated object may be an object for providing the image-based retrieval service within the user interface of the application displayed along with the user input. The image-based retrieval service may be a service for performing retrieval through information acquired on the basis of an image (for example, image recognition information). According to certain embodiments, the designated event may include reception of a predetermined input while the input unit is displayed. For example, the predetermined input may include a touch input of drawing a predetermined pattern. In another example, the predetermined input may include an input from another input means (for example, a stylus or a user's knuckle), distinct from the user's finger, while the input unit is displayed. In another example, the predetermined input may include a touch input having an intensity higher than a predetermined intensity. In another example, the predetermined input may include input performed on a physical button of the electronic device 101. However, this is not limiting. According to certain embodiments, the designated event may include reception of a predetermined gesture while the input unit is displayed. For example, the predetermined gesture may include a change in the orientation (posture) of the electronic device by the user holding the electronic device 101. However, this is not limiting. According to certain embodiments, the one or more images may be one or more images semi-persistently or temporarily stored in the memory 130 of the electronic device 101. According to certain embodiments, the processor 120 may identify the one or more images as one or more candidate images of the image-based retrieval service using the input unit.

In operation 315, the processor 120 may display at least some of the one or more images in association with the input unit. For example, this may include the thumbnail images 430 in FIG. 4 (second screen drawing). According to certain embodiments, at least some of the images may be images corresponding to the context of the electronic device 101. For example, some of the images may be corresponding to the type (or category) of the application, time during which operations 305 to 315 are performed, a service of the application, and the location of the electronic device. However, the disclosure is not limited to the foregoing. According to certain embodiments, the content may be configured in various formats. For example, the content may be configured with at least one character and/or at least one visual object. However, the disclosure is not limited to the foregoing.

According to certain embodiments, the processor 120 may display at least some images in association with the input unit by displaying at least some images within the display area of the input unit. For example, the processor 120 may display at least some images within a sub-screen of the input unit located in the display area of the input unit. The processor 120 may display at least some images within the sub-screen switched from another sub-screen of the input unit including the plurality of keys indicating a plurality of characters and the predetermined object. In another example, the processor 120 may display at least some images within a screen, at least a portion of which is superimposed on another sub-screen of the input unit. The screen on which at least some images are displayed may be the sub-screen of the input unit or a screen interworking with the input unit.

In operation 320, the processor 120 may acquire recognition information of at least a portion of the content included in the selected image. The image can be selected according to a predetermined input. The predetermined input may, for example, include a single-tap input. However, the disclosure is not limited to the foregoing. According to certain embodiments, acquisition of the recognition information may be performed completely by the processor 120, or may be performed through networking with another electronic device (for example, the electronic device 102, the electronic device 104, or the server 108) connected to or forming a wireless link with the electronic device 101. For example, when acquisition of the recognition information is performed completely by the processor 120, the processor 120 may extract at least one visual object from the selected image, identify at least one feature point from at least one extracted visual object, and generate the recognition information on the basis of the at least one feature point so as to acquire the recognition information. In another example, when acquisition of the recognition information is performed through networking with another electronic device, the processor 120 may transmit information on the selected image to another electronic device and receive the recognition information from the other electronic device so as to acquire the recognition information. According to certain embodiments, the information on the selected image transmitted by the processor 120 may include information on at least one visual object extracted from the selected image. According to certain embodiments, the information on the selected image transmitted by the processor 120 may include information on at least one feature point identified from at least one visual object. However, the disclosure is not limited to the foregoing.

In operation 325, the processor 120 may acquire character information corresponding to the recognition information on the basis of at least the acquisition. According to certain embodiments, the character information may be at least one keyword (or text) that can be used for the image-based retrieval service in order to retrieve other information. According to certain embodiments, the character information may be replaced with image information. In this case, the image information may be used for the image-based retrieval service in order to retrieve the other information.

In operation 330, the processor 120 may provide the character information to the application through the input unit as at least a portion of the user input. According to certain embodiments, the processor 120 may provide the character information to the application by inputting (or inserting) the character information into the character input portion included in the user interface of the application. According to certain embodiments, the provision of the character information to the application may be an operation for providing the character information to the application as at least a portion of the user input, in that a function that is the same as or similar to inputting a keyword through the plurality of keys included in the input unit is provided.

Although not illustrated in FIG. 3A, after providing the character information to the application, when the processor 120 acquires other character information as at least a portion of the user input through the input unit (for example, when the processor 120 acquires other character information through a plurality of keys included in the input unit), the processor 120 may store the other character information in association with the selected image. For example, the processor 120 may store the other character information as at least a portion of attribute information (for example, metadata) of the selected image. In another example, the processor 120 may store another file associated with an image file for the selected image and including the other character information. However, the disclosure is not limited to the foregoing.

Although not illustrated in FIG. 3A, the processor 120 may acquire resultant information processed using the character information and store the acquired resultant information in association with the selected image. For example, the processor 120 may store the resultant information as at least a portion of attribute information of the selected image. In another example, the processor 120 may store another file associated with an image file for the selected image and including the resultant information. However, the disclosure is not limited to the foregoing. The resultant information may be information retrieved on the basis of the character information and displayed within the user interface of the application as at least one of at least one piece of text or at least one image. However, the disclosure is not limited to the foregoing.

As described above, the electronic device 101 according to certain embodiments may provide an image-based retrieval service through the input unit while one application among a plurality of applications stored in the electronic device 101 is executed. The electronic device 101 according to certain embodiments may provide the image-based retrieval service independently from the type or category of the application being executed by providing the image-based retrieval service through the input unit. The electronic device 101 according to certain embodiments may simplify the user input required for calling the image-based retrieval service by providing the image-based retrieval service regardless of the type of the application being executed. In other words, the electronic device 101 according to certain embodiments may provide an enhanced user experience (UX) through the input unit providing the image-based retrieval service.

FIG. 3B illustrates another example of the operation of the electronic device according to certain embodiments. The operation may be performed by the electronic device 101 of FIG. 1, the electronic device 101 of FIG. 2B, or the processor 120 of the electronic device 101.

FIG. 4 illustrates an example of a screen displayed in the electronic device according to certain embodiments.

Referring to FIG. 3B, in operation 350, the processor 120 may display a user interface of an application. According to certain embodiments, the application may be an application distinct from another application used to control a virtual keyboard. According to certain embodiments, the application may be an application that can interwork with the other application. According to certain embodiments, the user interface of the application may be a screen related to the application displayed on the display device 160 while the application is executed. According to certain embodiments, the user interface of the application may be a screen for loading or displaying the virtual keyboard among a plurality of screens designated for the application.

In operation 355, the processor 120 may display a designated object and a plurality of keys indicating a plurality of characters within a display area of the virtual keyboard, at least a portion of which is superimposed on the user interface in response to identification of input on a text-input portion included in the user interface of the application. According to certain embodiments, the text-input portion may be included in the user interface in order to provide the retrieval service while the application is executed. According to certain embodiments, the text-input portion may be included in the user interface in order to provide the result of the retrieval service within the user interface while the application is executed. However, the disclosure is not limited to the foregoing. According to certain embodiments, the display area of the virtual keyboard may be an area superimposed on a lower area of the user interface. According to certain embodiments, the designated object may be an object for loading the image-based retrieval service illustrated in FIG. 3A. For example, the designated object may be disposed in proximity to at least one key among the plurality of keys. However, the disclosure is not limited to the foregoing.

For example, referring to FIG. 4, the processor 120 may display a user interface 400 on the display device 160. The processor 120 may receive input performed on a text-input portion 405 included in the user interface 400 while the user interface 400 is displayed. The processor 120 may display a virtual keyboard 410, at least a portion of which is superimposed on the user interface 400 in response to reception of the input performed on the text-input portion 405. The display area of the virtual keyboard 410 may be defined as an area 415. The virtual keyboard 410 may include a plurality of keys indicating a plurality of characters and a designated object 420. The designated object 420 may be referred to as a key, a button, or an item for loading a visual keyboard in that the designated object 420 provides the image-based retrieval service within the display area of the virtual keyboard 410.

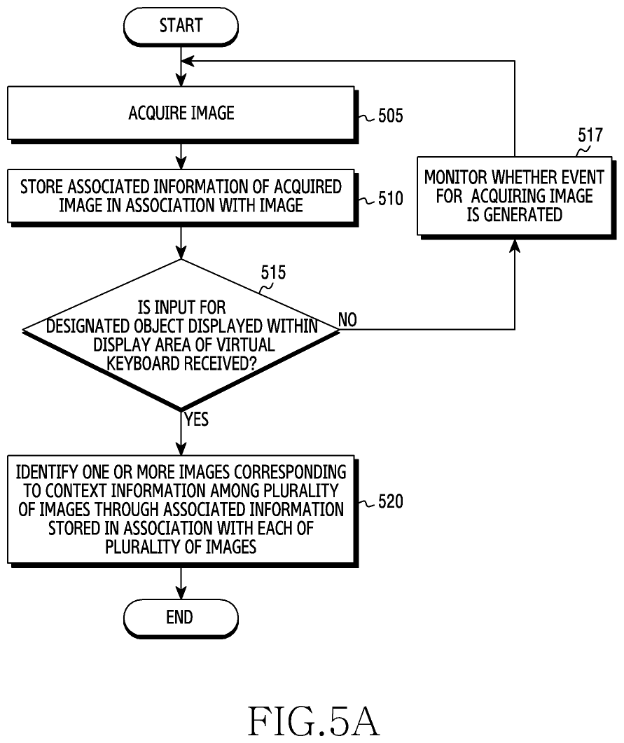

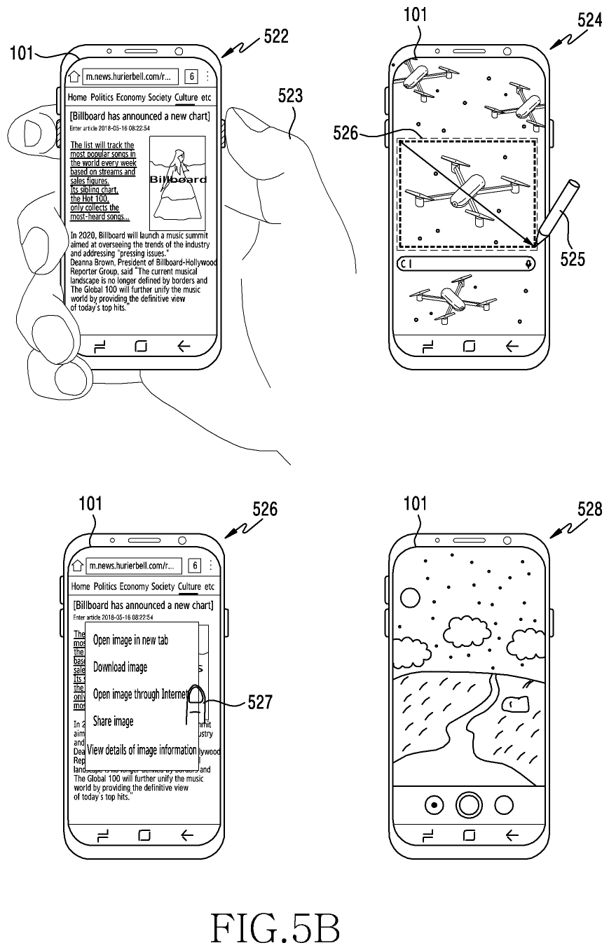

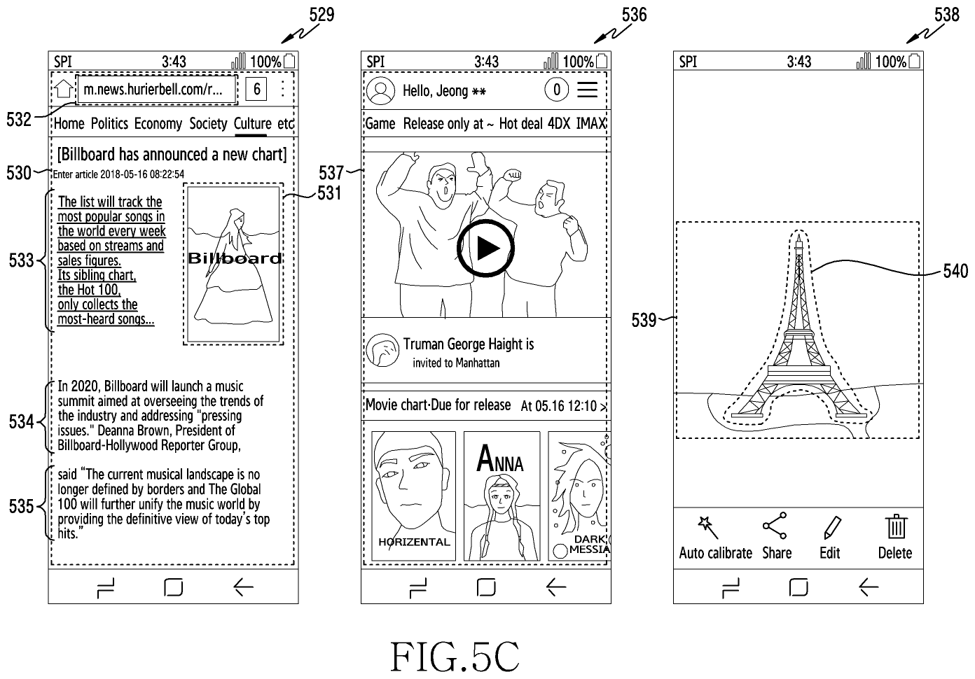

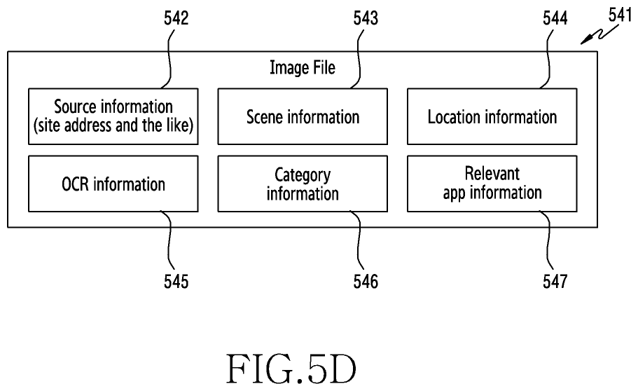

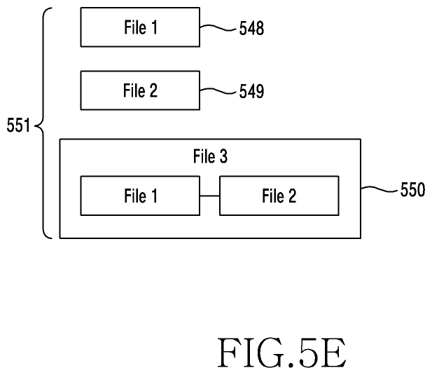

In operation 360, the processor 120 may identify one or more images related to the application among a plurality of images stored in the electronic device 101 on the basis of at least identification of the input performed on the designated object. According to certain embodiments, the one or more images related to the application being executed may be one or more images corresponding to context information of the electronic device 101 executing the application. For example, the one or more images may include an image containing content corresponding to the type (or category) of the application among the plurality of images. For example, the one or more images may include an image containing content corresponding to at least a portion of the time during which operations 350 to 360 are performed, among the plurality of images. For example, the one or more images may include an image containing content corresponding to a service provided by the application among the plurality of images. For example, the one or more images may include an image containing content corresponding to at least one application distinct from the application providing a service which is the same as or similar to the service provided by the application. For example, the one or more images may include an image containing content corresponding to the location of the electronic device 101 performing operations 350 to 360. For example, the one or more images may include an image acquired using the application or an image containing content acquired using the application, among the plurality of images. However, the disclosure is not limited to the foregoing. A detailed description of a method of storing the plurality of images in order to identify the one or more images among the plurality of images will be described below with reference to FIGS. 5A to 5E.

In operation 365, the processor 120 may display one or more thumbnail images for representing the one or more images within the display area of the virtual keyboard. For example, the processor 120 may display the one or more thumbnail images switched from the plurality of keys and the designated object within the display area of the virtual keyboard. According to certain embodiments, each of the one or more thumbnail images may be a reduced image of each of the one or more images. According to certain embodiments, the one or more thumbnail images may be used to provide the image-based retrieval service within the user interface of the application on the basis of the one or more images.

For example, referring to FIG. 4, the processor 120 may receive input 425 for the designated object 420 while the plurality of keys and the designated object 420 are displayed within the display area of the virtual keyboard 410. In response to reception of the input 425, the processor 120 may identify the one or more images related to the application among the plurality of images stored in the electronic device 101. For example, for a video-streaming application, the processor 120 may identify the one or more images including content such as movies or dramas (soap operas) among the plurality of images. The processor 120 may display some of the thumbnail images 430 to represent the one or more images within the display area 415 in response to identification. Alternatively, the plurality of keys and the designated object 420 may be replaced with some of the one or more thumbnail images 430 in response to identification of the one or more images. Each of the one or more thumbnail images 430 may include guidance 432 for guiding the user to select some of the one or more thumbnail images. The one or more thumbnail images 430 may be displayed along with at least one keyword (text or recommended word) acquired by the processor 120 while operations 350 to 365 are performed. According to certain embodiments, at least one keyword may be acquired on the basis of the conditions under which operations 350 to 365 are performed. According to certain embodiments, an area 434 for displaying at least one keyword may be located above the one or more thumbnail images 430. According to certain embodiments, the area 434 may be expanded on the basis of number of at least one displayed keyword.

As described above, the electronic device 101 according to certain embodiments may provide an enhanced user experience by providing the image-based retrieval service through the virtual keyboard 410. When the image-based retrieval service is provided through the virtual keyboard 410, the electronic device 101 according to certain embodiments may display the one or more thumbnail images for representing the one or more images that can be used for the image-based retrieval service, thereby providing information on the one or more images even though the display device 160 of the electronic device 101 has a limited area.

FIG. 5A illustrates an example of the operation of the electronic device storing an image according to certain embodiments. The operation may be performed by the electronic device 101 of FIG. 1, the electronic device 101 of FIG. 2B, or the processor 120 of the electronic device 101. Operations 505 to 520 of FIG. 5A may be related to operation 360 of FIG. 3B.

FIG. 5B illustrates an example of methods of acquiring the image by the electronic device according to certain embodiments.

FIG. 5C illustrates an example of methods of generating information associated with the image acquired by the electronic device according to certain embodiments.

FIG. 5D illustrates an example of a method of storing information associated with the image acquired by the electronic device according to certain embodiments.

FIG. 5E illustrates another example of a method of storing information associated with the image acquired by the electronic device according to certain embodiments.

Referring to FIG. 5A, in operation 505, the processor 120 may acquire an image. According to certain embodiments, the image may be acquired through various methods.

For example, referring to FIG. 5B, the processor 120 may acquire an image of the entire screen displayed on the display device 160 in response to reception of a designated input 523 like in context 522. For example, the designated input 523 may include an input of depressing at least one physical button among a plurality of physical buttons included in the electronic device 101. For example, the input of depressing at least one physical button may include an input of depressing both a volume-down button and a power button.

In another example, referring to FIG. 5B, the processor 120 may acquire an image of an area 526 identified by an input 525 within the entire screen displayed on the display device 160 in response to reception of the designated input 525 like in context 524. For example, the designated input 525 may be performed using an input means (for example, a user's finger or a stylus). For example, the designated input 525 may include input for designating an area on the displayed screen.

In another example, referring to FIG. 5B, the processor 120 may download an image included in the entire screen displayed on the display device 160 so as to acquire the image on the basis of reception of a designated input 527, like in context 526. For example, the designated input 527 may include an input of allowing an input means to remain over the image included in the entire displayed screen beyond a designated time. In another example, the designated input 527 may include an input of holding the image included in the entire displayed screen over the designated time.

In another example, referring to FIG. 5B, the processor 120 may acquire an image through the camera module 180 included in the electronic device 101 as in context 528. When the image is acquired through the camera module 180, the processor 120 may display a preview image for the image on the display device 160.

In operation 510, the processor 120 may store information associated with the acquired image in association with the image. According to certain embodiments, the associated information may be information associated with the image or context in which the image is acquired. For example, the associated information may include recognition information acquired by recognizing the content of the image. The recognition may be performed completely by the processor 120 or through networking with another electronic device (for example, the electronic device 102, the electronic device 104, or the server 108). According to certain embodiments, the recognition information may include data acquired by applying Optical Character Reader (OCR) to text included in the image. The recognition information may include scene data of the image acquired through image recognition for the image, or data on the category of at least one visual object included in the image acquired through image recognition for the image. In another example, the associated information may include information on the source from which the image was acquired. According to certain embodiments, the information on the source may include an address of a webpage including the image or data on a markup language file for the webpage. According to certain embodiments, the information on the source may include data on at least one keyword used by the webpage in order to retrieve the image. According to certain embodiments, the information on the source may include data on an application (or the type of the application) used to acquire the image. In another example, the associated information may include data on the time at which the image was acquired. In another example, the associated information may include data on the location (for example, a geographical location or a Point of Interest (POI)) of the electronic device 101 at which the electronic device 101 acquired the image. In another example, the associated information may include data on at least one application (or a type of at least one application) executed by the electronic device 101 at the time at which the image was acquired. However, the disclosure is not limited to the foregoing.

According to certain embodiments, while acquiring the associated information or before storing the associated information, the processor 120 may display a message that inquires about whether the associated information corresponds to the user's intention on the display device 160. The processor 120 may modify the associated information on the basis of user input for modifying the associated information in response to reception of the input of the message. The modified associated information may include content modified on the basis of the user input or user memo (or user annotation) input based on the user input.

For example, referring to FIG. 5C, the processor 120 may acquire an image of an entire webpage 530 through a screen capture function available by the electronic device 101, or may acquire an image of a visual object 531 included in the webpage 530 as in context 529. When the image of the entire webpage 530 is acquired, the processor 120 may acquire the associated information including data such as the address 532 (URL) of the webpage, the markup language file of the webpage (not illustrated in FIG. 5C), recognition data on an article included in the webpage, a visual object 531 included in the webpage, the time at which the image was acquired, the location at which the electronic device 101 was located and store the acquired associated information in association with the image of the entire webpage 530.

When the image of at least one object 531 is acquired, the processor 120 may acquire the associated information including an address 532 of the webpage, a markup language file of the webpage, recognition data on at least one visual object 531, recognition data (identified on the basis of the recognition information on at least one visual object 531) on content (for example, an article 533, an article 534, or an article 535) located near at least one visual object 531, data on the time at which the image of at least one visual object 531 was acquired, and data on the location at which the electronic device 101 was located at the time at which the image was acquired and store the acquired associated information in association with the image of at least one visual object 531. However, the disclosure is not limited to the foregoing.

In another example, referring to FIG. 5C, the processor 120 may acquire an image of at least a portion of a user interface 537 of an movie reservation application through a capture function available by the electronic device 101 as in context 536. The processor 120 may acquire the associated information including data indicating that the image is acquired from the movie reservation application, recognition data on content included in the image, the time at which the image was acquired, and the location at which the electronic device 101 was located and store the acquired associated information in association with the image on the basis of at least the acquisition of the image. However, the disclosure is not limited to the foregoing.

In another example, referring to FIG. 5C, the processor 120 may use the camera module 180 to acquire an image 539 as in context 538. The processor 120 may recognize the image 539 as the Eiffel Tower. The processor 120 may acquire the associated information including recognition data on the image 539, the time at which the image 539 was acquired, and the location the electronic device 101 was located when the image 539 was acquired, and store the acquired associated information in association with the image. However, the disclosure is not limited to the foregoing.

According to certain embodiments, the processor 120 may store the associated information in association with the image through various methods. According to certain embodiments, the processor 120 may store the associated information in association with the image by inserting the associated information into an image file of the image. For example, the processor 120 may store the associated information in association with the image by inserting the associated information into metadata (or header information) of the image file of the image. According to certain embodiments, the processor 120 may insert the associated information into another file distinct from the image file of the image. In this case, the processor 120 may generate or acquire an associated file for associating the image file with the other file, the associated file being distinct from the image file and the other file into which the associated information is inserted. For example, the associated file may include a markup language file for associating the image file with the other file. However, the disclosure is not limited to the foregoing.

For example, referring to FIG. 5D, the processor 120 may store the associated information in association with the image by storing an image file 541 of the image including the associated information. The image file 541 may include source information 542 of the image, scene information 543 of the image, location information 544 indicating the location of the electronic device 101 at the time at which the image was acquired, OCR information 545 on the result generated by applying OCR to the image, category information 546 of the image, and relevant app information 547 of the image as well as information on the image. The source information 542, the scene information 543, the location information 544, the OCR information 545, the category information 546, and the relevant app information 547 may be included in metadata (or header information) within the image file 541. The category information 546 may be acquired by analyzing the source information 542, the scene information 543, the location information 544, the OCR information 545, and the relevant app information 547. Acquisition of the category information 546 may be performed completely by the processor 120, or may be performed through networking between the electronic device 101 and the other electronic device. The relevant app information 547 may be acquired by analyzing at least one piece of the source information 542, the scene information 543, the location information 544, the OCR information 545, and the category information 546. Acquisition of the relevant app information 547 may be performed completely by the processor 120, or may be performed through interworking between the electronic device 101 and the other electronic device.

Although not illustrated in FIGS. 5A to 5D, on the basis of associated information included in an image file 541 and associated information included in each of image files previously stored in the electronic device 101, the processor 120 may classify the image file and the image files. For example, on the basis of at least one piece of the associated information, the processor 120 may classify the image file and a first image file of the image files as a first category, among a plurality of categories, and classify the image file and a second image file of the image files as a second category, among the plurality of categories. When input performed on a designated object included in the virtual keyboard is received through such classification, the processor 120 may identify one or more image files corresponding to the context at the time at which the input performed on the designated object was received, among a plurality of image files stored in the electronic device 101.

In another example, referring to FIG. 5E, the processor 120 may store an image file (file 1) 548 of the image, another file (file 2) 549 distinct from the image file and including the associated information, and an associated file (file 3) 550 for associating the image file with the other file in one dataset 551 and thus store the associated information in association with the image. According to certain embodiments, the dataset 551 may be formed by inserting the image file 548, another file 549, and the associated file 550 into one folder. According to certain embodiments, the dataset 551 may be formed by inserting information on an address in the memory 130 at which at least one of another file 549 and the associated file 550 are stored into the image file 548, inserting information on an address in the memory 130 at which at least one of the image file 548 and the associated file 550 are stored into another file 549, and inserting information on an address in the memory 130 at which at least one of the image file 548 and another file 549 are stored into the associated file 550. However, the disclosure is not limited to the foregoing.

Although not illustrated in FIGS. 5C and 5E, the processor 120 may classify the image file 548 and the image files on the basis of at least another file 549 and the associated file 550 related to the image file 548 and other files and associated files related to the image files previously stored in the electronic device 101. For example, the processor 120 may classify a first image file of the image files as a first category among a plurality of categories and classify the image file and a second image file of the image files as a second category among the plurality of categories on the basis of at least the files related to the image files and the image file 548. When input performed on a designated object included in the virtual keyboard is received through such classification, the processor 120 may identify one or more image files corresponding to the context at the time at which the input performed on the designated object was received or an application executed along with the virtual keyboard, among a plurality of image files stored in the electronic device 101.

In operation 515, the processor 120 may monitor whether input performed on the designated object displayed within the display area of the virtual keyboard is received. For example, the processor 120 may initiate monitoring under a condition of identifying that the virtual keyboard is displayed along with the user interface of the application stored in the electronic device 101. The processor 120 may perform operation 517 on the basis of identification that a predetermined time passes from the time at which the virtual keyboard is displayed until reception of the input performed on the designated object is monitored or in the state in which the input performed on the designated object is not received. The processor 120 may perform operation 520 on the basis of monitoring of reception of the input performed on the designated object.

In operation 517, the processor 120 may monitor whether an event for acquiring an image is generated in the electronic device 101 on the basis of identification that a predetermined time passes from the time at which the virtual keyboard is displayed until reception of the input performed on the designated object is monitored or in the state in which the input performed on the designated object is not received. The processor 120 may perform operation 505 again in response to monitoring of the generation of the event in the electronic device 101.

In operation 520, the processor 120 may identify one or more images corresponding to context information (or an application) of the electronic device 101 among the plurality of images through associated information stored in association with the plurality of images on the basis of monitoring of reception of the input performed on the designated object. For example, the processor 120 may acquire the context information on the basis of at least the content of the application being executed, the type of the application being executed, and the current location of the electronic device 101, and identify the one or more images corresponding to the acquired context information from a plurality of images classified on the basis of the above-described classification.

As described above, in a step of acquiring an image, the electronic device 101 according to certain embodiments may acquire information associated with the acquired image and store the associated information in association with the image, thereby providing the image-based retrieval service through the virtual keyboard.

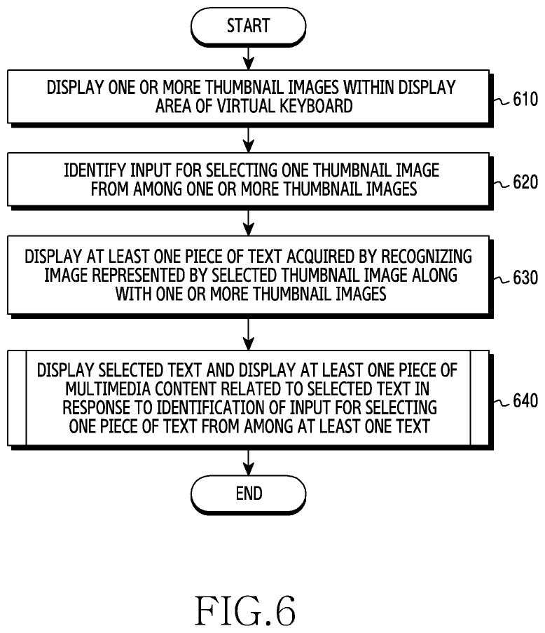

FIG. 6 illustrates an example of the operation of the electronic device providing an image-based retrieval service through a virtual keyboard according to certain embodiments. The operation may be performed by the electronic device 101 of FIG. 1, the electronic device 101 of FIG. 2B, or the processor 120 of the electronic device 101.

Operations 610 to 640 of FIG. 6 may be related to operation 365 of FIG. 3B.

Referring to FIG. 6, in operation 610, the processor 120 may display one or more thumbnail images within the display area of the virtual keyboard. According to certain embodiments, the one or more thumbnail images may include one or more thumbnail images defined in FIG. 3B, the virtual keyboard may include the virtual keyboard defined in FIG. 3B, and the display area may include the display area defined in FIG. 3B. According to certain embodiments, operation 610 may correspond to operation 365 of FIG. 3B.

In operation 620, the processor 120 may identify input of selecting one thumbnail image from among the one or more thumbnail images. For example, referring to FIG. 4, the processor 120 may identify the input 436 for the guide 432 as at least a portion of the input of selecting one thumbnail image 438 among one or more thumbnail images 430.

In operation 630, the processor 120 may recognize an image represented by the selected thumbnail image so as to display at least one acquired piece of text (for example, a keyword) along with the one or more thumbnail images. According to certain embodiments, at least one piece of text may be acquired on the basis of the associated information described with reference to FIGS. 5A to 5E. According to certain embodiments, at least one keyword may be acquired by recognizing the image represented by the selected thumbnail image in response to identification of the input of selecting the thumbnail image among the one or more thumbnail images.

For example, referring to FIG. 4, the processor 120 may recognize the image represented by the thumbnail image 438 selected by the input 436 in response to reception of the input 436 so as to display at least one acquired piece of text 440 along with one or more thumbnail images 430. According to certain embodiments, the at least one piece of text 440 may be located above the one or more thumbnail images 430. According to certain embodiments, at least one piece of text 440 may be identified on the basis of at least the associated information and context information (for example, context information related to the application being executed) related to the electronic device 101. According to certain embodiments, the at least one piece of text 440 may be candidate text which can be input to the text-input portion 405.

In operation 640, the processor 120 may display the selected text within the text-input portion in response to identification of the input of selecting one piece of text among the at least one piece of text and display at least one piece of multimedia content related to the selected text within the user interface of the application being executed. According to certain embodiments, the at least one piece of multimedia content may be information (or resultant information) retrieved on the basis of at least one piece of text. According to certain embodiments, the at least one piece of multimedia content may be acquired from a server related to the application or acquired from the memory 130 of the electronic device 101. However, the disclosure is not limited to the foregoing.

For example, referring to FIG. 4, the processor 120 may receive the input 442 for selecting one piece of text from among at least one piece of text 440. The processor 120 may display the text-input portion 405 including the text 444 selected by the input 442 in response to reception of the input 442 and display at least one piece of multimedia content 446 retrieved on the basis of the text 444 within the user interface 400.

Although not illustrated in FIG. 4, the processor 120 may display at least one piece of text at least partially distinct from at least one piece of text 440 within the area 434 in response to reception of the input of selecting another thumbnail distinct from the thumbnail image 438 among one or more thumbnail images 430 while at least one piece of multimedia content 446 is displayed. The processor 120 may display at least one piece of multimedia content related to the selected content within the user interface 400 in response to reception of the input of selecting one piece of text among the at least one piece of text displayed in the area 434. In this case, at least one piece of multimedia content 446 may be replaced with at least one piece of multimedia content related to the selected text.

FIGS. 4 and 6 illustrate an example of selecting one thumbnail image from among one or more thumbnail images and an example of selecting one piece of text from among at least one piece of text, but are only provided for convenience of description. It should be noted that the electronic device 101 according to certain embodiments may provide a function for selecting two or more thumbnail images from among the one or more thumbnail images and a function for selecting two or more pieces of text from among the at least one piece of text.

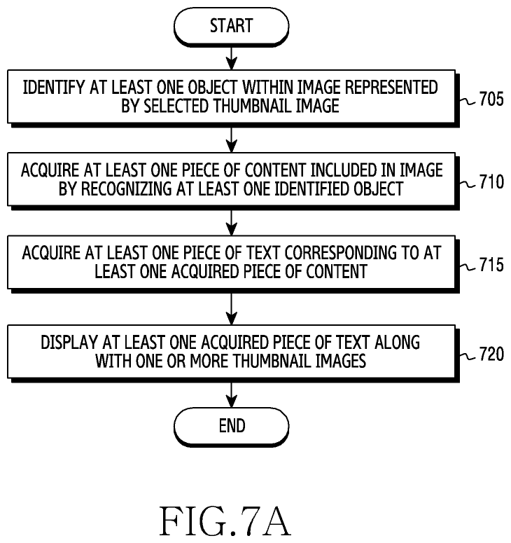

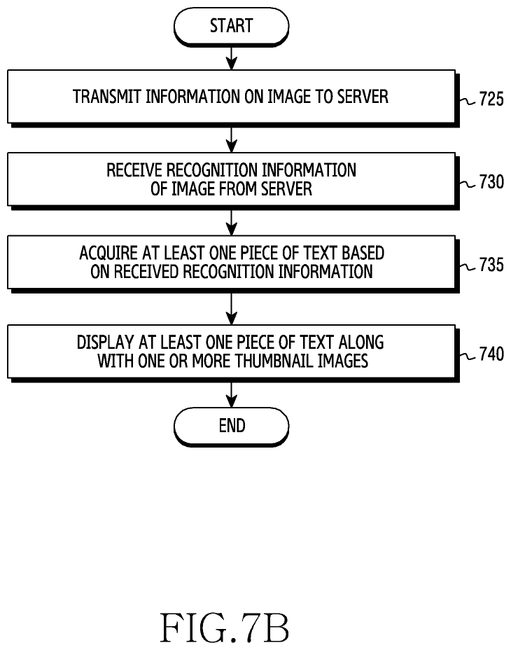

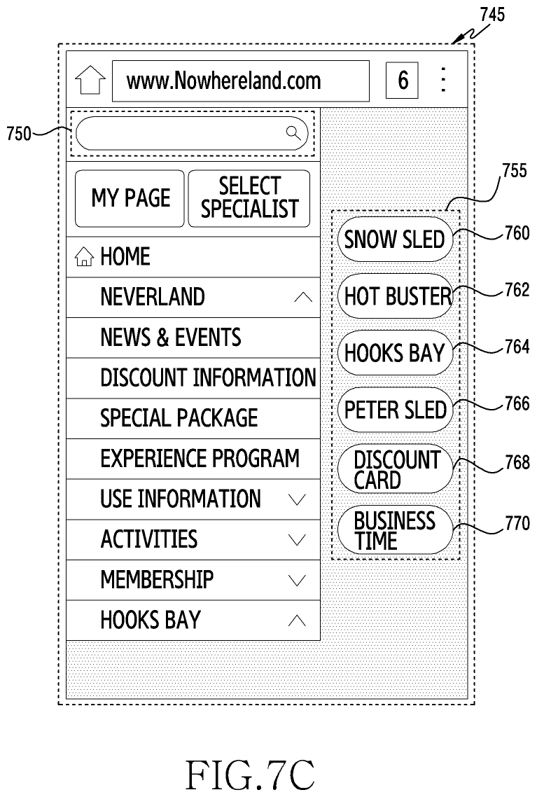

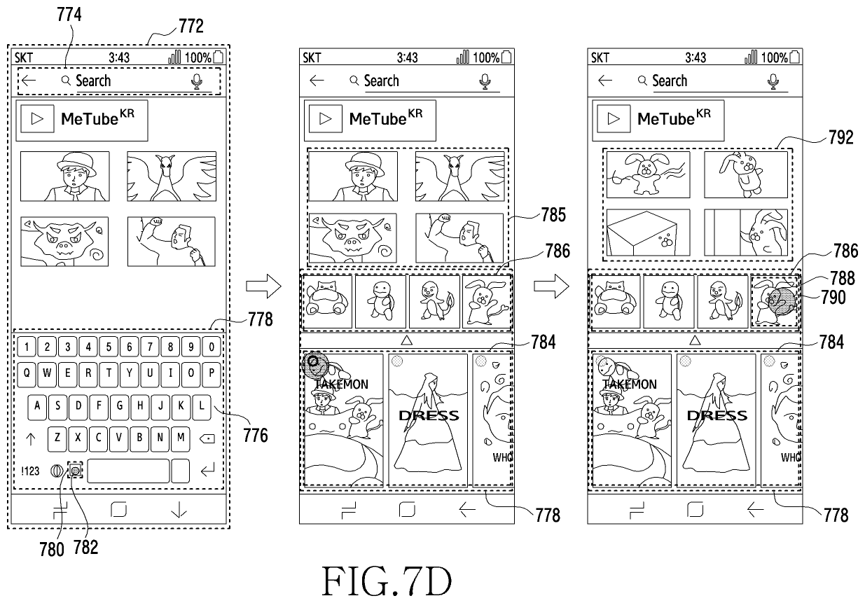

FIG. 7A illustrates an example of the operation of the electronic device acquiring at least one piece of text according to certain embodiments. The operation may be performed by the electronic device 101 of FIG. 1, the electronic device 101 of FIG. 2B, or the processor 120 of the electronic device 101. Operations 705 to 720 of FIG. 7A may be related to operation 355 of FIG. 3B.

FIG. 7B illustrates another example of the operation of the electronic device acquiring at least one piece of text according to certain embodiments. The operation may be performed by the electronic device 101 of FIG. 1, the electronic device 101 of FIG. 2B, or the processor 120 of the electronic device 101. Operations 725 to 740 of FIG. 7B may be related to operation 355 of FIG. 3B.

FIG. 7C illustrates an example of a method of displaying at least one piece of text by the electronic device according to certain embodiments.

FIG. 7D illustrates an example of a screen displayed in the electronic device according to certain embodiments.

FIGS. 7A to 7C illustrates an example of an operation in which the electronic device 101 receives an input of selecting one thumbnail image from among one or more thumbnail images and then recognizing an image represented by the selected thumbnail image. The operation may be performed along with the operation of the electronic device 101 illustrated in FIGS. 5A to 5E, or may be performed independently from the operation of the electronic device 101 illustrated in FIGS. 5A to 5E.

Referring to FIG. 7A, in operation 705, the processor 120 may identify at least one object within an image represented by a thumbnail image selected by an input. According to certain embodiments, the at least one object may include at least one of text included in the image, a partial image included in the image, and a hash tag included in the image. The processor 120 may identify at least one object from the image in order to recognize the image.

In operation 710, the processor 120 may acquire at least one piece of content included in the image by recognizing at least one identified object. For example, the processor 120 may extract at least one feature point of at least one object from at least one identified object and recognize at least one image on the basis of at least one extracted feature point. For the recognition, the processor 120 may use at least one of a natural-language-processing module and an image-processing module included in the electronic device 101.

FIG. 7A illustrates an example of using recognition of the image in order to acquire at least one piece of content, but is only provided for convenience of description. The electronic device 101 according to certain embodiments may not only recognize the image but also acquire at least one piece of content from information displayed along with the image or the source of the image when the image is acquired.

In operation 715, the processor 120 may acquire at least one piece of text corresponding to at least one acquired piece of content. For example, the processor 120 may acquire representative text representing at least one piece of text and acquire text corresponding to a synonym, a similar word, and/or a hyponym of the representative text so as to acquire at least one piece of text corresponding to at least one piece of content.

In operation 720, the processor 120 may display at least one acquired piece of text along with the one or more thumbnail images. Alternatively, when the display area of the display device 160 is limited, the processor 120 may display only the at least one acquired piece of text. For example, the processor 120 may terminate (or cease) display of the one or more thumbnail images and display at least one acquired piece of text on the basis of acquisition of at least one piece of text. The at least one acquired piece of text may be displayed in the vicinity of the text-input portion within the user interface of the application being executed. For example, referring to FIG. 7C, on the basis of acquisition of at least one piece of text, the processor 120 may display the at least one acquired piece of text 755 within a pop-up area in the vicinity of the text-input portion 750 within the user interface 745 of the application being executed. The at least one piece of text 755 may include text 760, text 762, text 764, text 766, text 768, and text 770. The text 760, the text 762, the text 764, the text 766, the text 768, and the text 770 may be identified on the basis of at least one of the OCR result for the image represented by the selected thumbnail image, scene (or landmark) information of the image, the location (for example, geographical location or POI) at which the image is acquired, a user tag related to the image, a keyword frequently input at the location (for example, webpage) at which the image is acquired, and tag information included in the location (for example, the address of an SNS service webpage referring to the webpage) related to the location at which the image is acquired.

As described above, since the electronic device 101 according to certain embodiments not only acquires associated information on the image at the time at which the image was acquired or stored but also acquires content related to the image represented by the selected image by performing processing related to the image represented by the selected thumbnail image in response to reception of the input of selecting one thumbnail image from among the one or more thumbnail images, the electronic device 101 may provide at least one character (for example, a keyword) reflecting a trend change in a time interval between an image acquisition time and an image-loading time.

Referring to FIG. 7B, in operation 725, the processor 120 may transmit information on the image represented by the selected thumbnail image to the server. According to certain embodiments, the server may be a server used to acquire information related to the image. According to certain embodiments, the server may be a server used to acquire recognition information on the image. According to certain embodiments, the server may include one server or a plurality of different servers. According to certain embodiments, the information on the image may include information on at least one visual object extracted from the image. According to certain embodiments, the information on the image may include information on at least one feature point of at least one visual object.

In operation 730, the processor 120 may receive recognition information on the image from the server. The recognition information may be received from the server through the communication module 190.

In operation 735, the processor 120 may acquire at least one piece of text on the basis of the received recognition information. For example, the processor 120 may acquire at least one piece of text by extracting data on at least one piece of text from the received recognition information. In another example, the processor 120 may perform Internet retrieval based on the recognized recognition information and acquire at least one piece of text on the basis of the retrieval result. However, the disclosure is not limited to the foregoing.

In operation 740, the processor 120 may display at least one acquired piece of text along with the one or more thumbnail images. Alternatively, the processor 120 may display only at least one acquired piece of text within the user interface of the application being executed.

As described above, the electronic device 101 according to certain embodiments may acquire the result of processing the image and/or at least one piece of text acquired from the result of processing the image through at least one other electronic device outside the electronic device 101 as well as the elements (for example, the processor 120 and the memory 130) within the electronic device 101. In other words, the electronic device 101 according to certain embodiments may provide the retrieval results having diversity through the virtual keyboard on the basis of data stored outside the electronic device 101 as well data stored in the electronic device 101.

Alternatively, the processor 102 may use a reduced image distinct from at least one acquired piece of text as a keyword of the retrieval service using the virtual keyboard.

For example, referring to FIG. 7D, the processor 120 may display a user interface 772 on the display device 160. The processor 120 may receive input performed on a text-input portion 774 included in the user interface 772 while the user interface 772 is displayed. The processor 120 may display a virtual keyboard 776, at least a portion of which is superimposed on the user interface 772 in response to reception of the input performed on the text-input portion 774. The display area of the virtual keyboard 776 may be defined as an area 778. According to certain embodiments, the size (or area) of the area 778 may be changed depending on the amount of content included in the area 778. The virtual keyboard 776 may include a plurality of keys indicating a plurality of characters and a designated object 780. The processor 120 may display one or more thumbnail images 784 for representing one or more images corresponding to context information related to the electronic device 101 among a plurality of images stored in the electronic device 101 within an extended area 778 in response to reception of input 782 performed on the designated object 780. The processor 120 may display at least one reduced image 786 related to the selected thumbnail image in response to reception of the input of selecting one thumbnail image from among one or more thumbnail images 784. The processor 120 may display at least one piece of multimedia content 790 switched from at least one previously displayed multimedia content 785 within the user interface 772 in response to reception of the input 790 for selecting one reduced image 788 among at least one reduced image 786.

As described above, the electronic device 101 according to certain embodiments may provide not only the image-based retrieval service using text through the virtual keyboard but also the image-based retrieval service using a reduced image. The electronic device 101 according to certain embodiments may retrieve information that is not specified in a text format by providing the service.

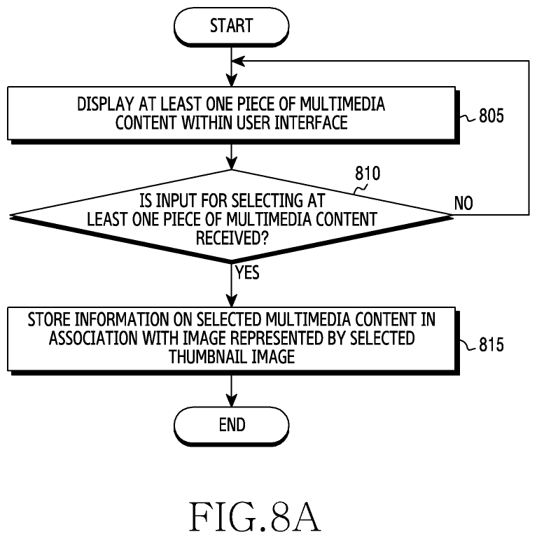

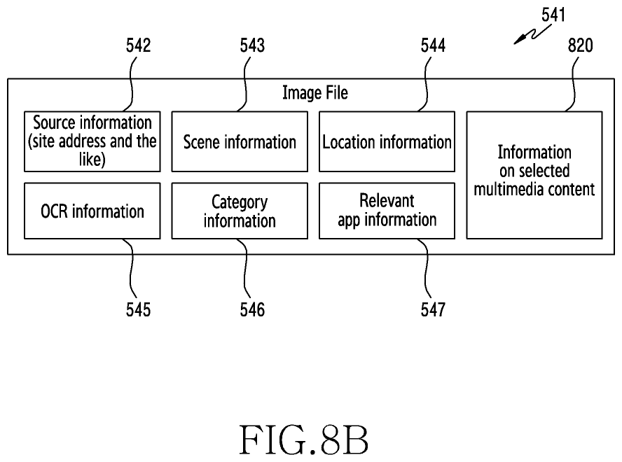

FIG. 8A illustrates an example of the operation of the electronic device storing retrieved multimedia content in association with an image according to certain embodiments. The operation may be performed by the electronic device 101 of FIG. 1, the electronic device 101 of FIG. 2B, or the processor 120 of the electronic device 101. Operations 805 to 815 of FIG. 8A may be related to operation 640 of FIG. 6.

FIG. 8B illustrates an example of a method of storing information associated with an image acquired by the electronic device according to certain embodiments.

Referring to FIG. 8A, in operation 805, the processor 120 may display at least one piece of multimedia content within a user interface. According to certain embodiments, operation 805 may correspond to operation 640 of FIG. 6.

In operation 810, the processor 120 may monitor whether input of receiving at least one piece of multimedia content is received while at least one piece of multimedia content is displayed within the user interface. When the input of receiving at least one piece of multimedia content is received while at least one piece of multimedia content is displayed, the processor 120 may perform operation 815. On the other hand, when the input of receiving at least one piece of multimedia content is not received while at least one piece of multimedia content is displayed, the processor 120 may maintain the display of at least one piece of multimedia content within the user interface. According to certain embodiments, the display of at least one piece of multimedia content may be maintained for a predetermined time. In this case, the processor 120 may stop displaying at least one piece of multimedia content in response to identification that the predetermined time has passed from the time at which at least one piece of multimedia content was displayed.

In operation 815, the processor 120 may store information on the selected piece of multimedia content in association with an image represented by the selected thumbnail image on the basis of reception of the input of selecting at least one piece of multimedia content. According to certain embodiments, when information on the selected piece of multimedia content is stored in association with the image and the image is used for retrieval, the processor 120 may identify at least one character (for example, a keyword) not only on the basis of information acquired during a process of acquiring the image but also on the basis of information on the selected piece of multimedia content.

According to certain embodiments, the processor 120 may use various methods to store at least one piece of multimedia content in association with the image. For example, referring to FIG. 8B, the processor 120 may store the multimedia content in association with the image by storing the image file 541 of the image represented by the selected thumbnail image including the associated information to which the information on at least one piece of multimedia content is added. For example, the image file 541 may include information 820 on the selected piece of multimedia content as well as associated information (for example, source information 542, scene information 543, location information 544, OCR information 545, category information 546, and relevant app information 547) acquired during the process of acquiring the image. According to certain embodiments, the information 820 on the multimedia content may be included in metadata within the image file 541, along with the source information 542, the scene information 543, the location information 544, the OCR information 545, the category information 546, and the relevant app information 547. According to certain embodiments, the information 820 on the multimedia content may include at least one piece of data on a link to a webpage used to retrieve the multimedia content and data on an image of a screen displayed while the multimedia content is retrieved. However, the disclosure is not limited to the foregoing.

In another example, the processor 120 may insert information on the selected piece of multimedia content into an independent file and store information on the relationship between the file into which the information on the selected piece of multimedia content is added and other files in the associated file 550 so as to store at least one piece of multimedia content in association with the image.

As described above, the electronic device 101 according to certain embodiments may provide a user-specific service by storing data (that is, data on the selected piece of multimedia content) on the result of the image-based retrieval service through the virtual keyboard in association with the image used to provide the image-based retrieval service.

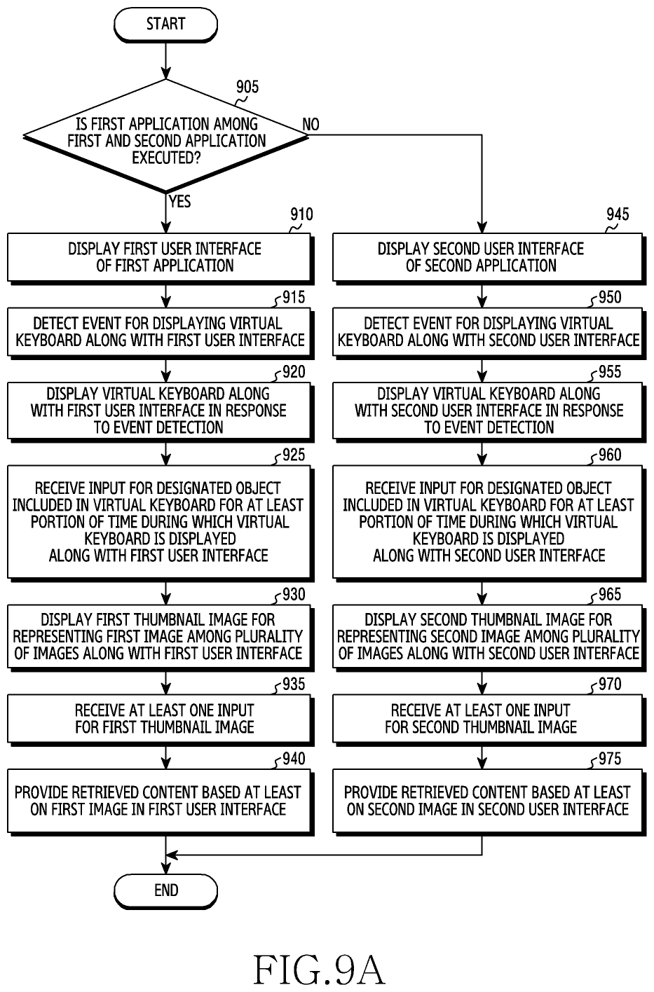

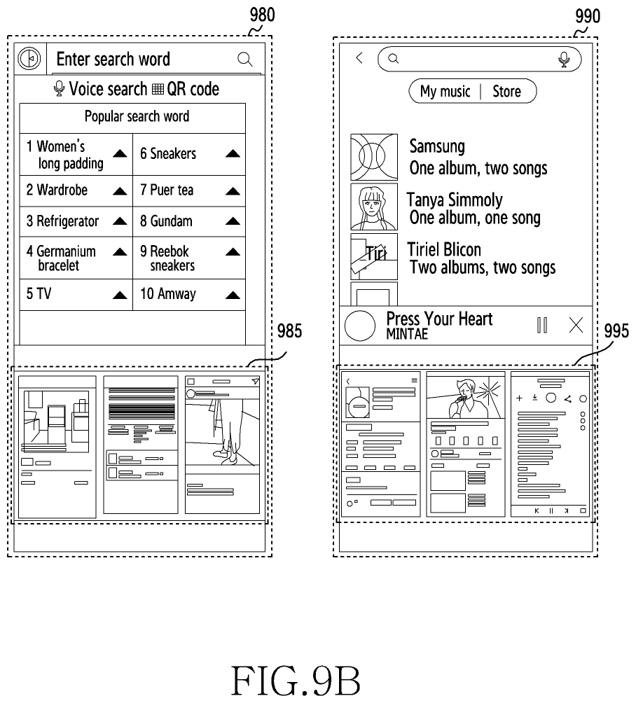

FIG. 9A illustrates another example of the operation of the electronic device according to certain embodiments. The operation may be performed by the electronic device 101 of FIG. 1, the electronic device 101 of FIG. 2B, or the processor 120 of the electronic device 101.

FIG. 9B illustrates an example of a screen of the electronic device providing different thumbnail images depending on the type of the application that is provided along with a virtual keyboard according to certain embodiments.

Referring to FIG. 9A, in operation 905, the processor 120 may identify that a first application is executed, among the first application and a second application stored in the electronic device 101. According to certain embodiments, the first application may be an application providing another service distinct from the service provided by the second application.

In operation 910, the processor 120 may display a first user interface of the first application on the display device 160 in response to execution of the first application.

In operation 915, the processor 120 may detect an event for displaying the virtual keyboard along with the first user interface. The virtual keyboard may include a designated object for providing the image-based retrieval service.

In operation 920, the processor 120 may display the virtual keyboard along with the first user interface in response to detection of the event. In operation 925, the processor 120 may receive input performed on the designated object while the virtual keyboard is displayed along with the first user interface. In operation 930, the processor 120 may display a first thumbnail image for representing a first image among a plurality of images stored in the electronic device 101 along with the first user interface in response to reception of the input. The first image may be an image related to the service provided by the first application among the plurality of images.

In operation 935, the processor 120 may receive at least one input performed on the first thumbnail image. In operation 940, the processor 120 may provide content retrieved on the basis of at least the first image within the first user interface in response to reception of at least one input performed on the first thumbnail image. According to certain embodiments, the content may be content stored in association with the first image.

Alternatively, the processor 120 may display a second user interface of the second application on the display device 160 in response to execution of the second application in operation 945.

In operation 950, the processor 120 may detect an event for displaying the virtual keyboard along with the second user interface. In operation 955, the processor 120 may display the virtual keyboard along with the second user interface in response to detection of the event. In operation 960, the processor 120 may receive the input performed on the designated object included in the virtual keyboard while the virtual keyboard is displayed along with the second user interface.

In operation 965, the processor 120 may display a second thumbnail image for representing a second image among the plurality of images along with the second user interface in response to reception of the input. The second image may be an image related to the service provided by the second application among the plurality of images. The second image may be an image distinct from the first image.

For example, referring to FIG. 9B, the processor 120 may provide at least one first thumbnail image 985 along with a user interface 980 of the first application in response to reception of the input performed on the designated object included in the virtual keyboard displayed along with the first application. Since the first application is an application providing a shopping service, at least one first thumbnail image 985 may represent an image related to an item that can be purchased, among a plurality of images stored in the electronic device 101. Unlike the case in which the image-based retrieval service is provided using the virtual keyboard within the user interface 980 of the first application, the processor 120 may provide at least one second thumbnail image 995 along with the user interface 990 of the second application in response to reception of the input performed on the designated object included in the virtual keyboard displayed along with the second application. Since the second application is an application providing a music service, unlike the first application, at least one second thumbnail image 995 may represent an image related to music, among the plurality of images stored in the electronic device 101, unlike the at least one first thumbnail image 985. In other words, the processor 120 according to certain embodiments may recommend, as an image for the image-based retrieval service, different images depending on the type of the application providing the user interface displayed along with the virtual keyboard at the time at which the input performed on the designated object included in the virtual keyboard is received.

In operation 970, the processor 120 may receive at least one input performed on the second thumbnail image. In operation 975, the processor 120 may provide other content retrieved on the basis of the second image within the second user interface in response to reception of at least one input performed on the second thumbnail image. The other content may be distinct from the content. The other content may be content stored in association with the second image, distinct from the first image.

FIG. 9A illustrates an example in which, when an application is changed, the image recommended for the image-based retrieval service is changed, but this is only provided for convenience of description. When one application provides a plurality of services, the electronic device 101 according to certain embodiments may change the recommend image depending on the type of the provided application. For example, when a first service is provided through a first application that is being executed, the processor 120 may display a first thumbnail image for representing a first image in response to reception of the input performed on the designated object included in the virtual keyboard. When a second service is provided through the first application being executed, the processor 120 may display a second thumbnail image for representing a second image distinct from the first image in response to reception of the input performed on the designated input included in the virtual keyboard. However, the disclosure is not limited to the foregoing.

As described above, the electronic device 101 according to certain embodiments may recommend different images for the image-based retrieval service depending on the type of the application. The electronic device 101 according to certain embodiments may provide an enhanced user experience through the recommendation.

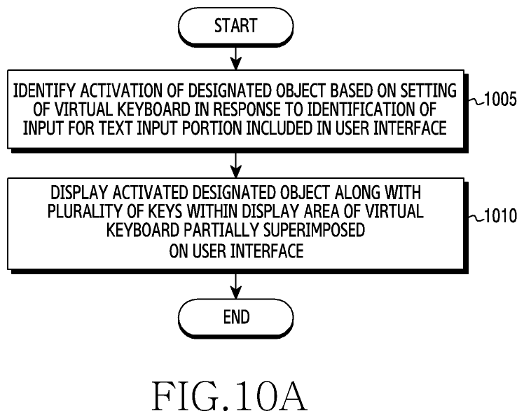

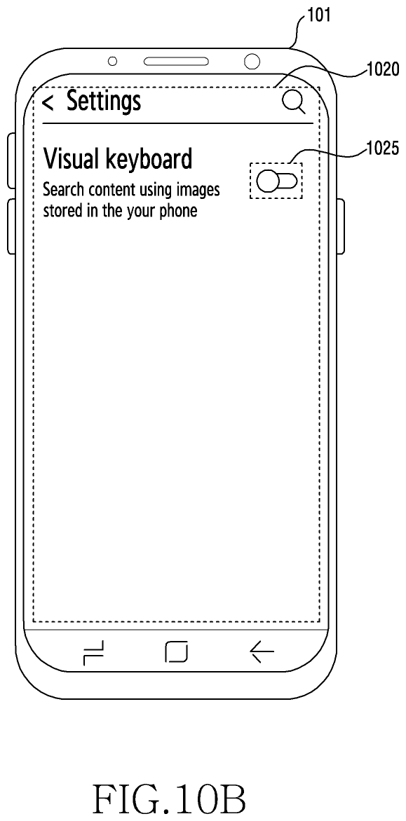

FIG. 10A illustrates an example of the operation of the electronic device displaying a designated object along with a plurality of keys according to certain embodiments. The operation may be performed by the electronic device 101 of FIG. 1, the electronic device 101 of FIG. 2B, or the processor 120 of the electronic device 101. Operations 1005 and 1010 of FIG. 10A may be related to operation 355 of FIG. 3B.

FIG. 10B illustrates an example of a method of configuring a visual keyboard function according to certain embodiments.

Referring to FIG. 10A, in operation 1005, the processor 120 may perform identification to activate the designated object on the basis of configuration of the virtual keyboard in response to identification of the input performed on the text-input portion included in the user interface of the application being executed. For example, referring to FIG. 10B, the electronic device 101 may include a setting 1020 for determining whether to activate the visual keyboard function as one of settings. According to certain embodiments, the visual keyboard function may mean an offer of a function of providing the image-based retrieval service through the virtual keyboard. According to certain embodiments, the visual keyboard may mean provision of the virtual keyboard including the activated designated object. According to certain embodiments, the setting 1020 may include an item 1025 for determining whether to activate the visual keyboard function. The processor 120 may perform identification to activate the designated object on the basis of identification of activation of the visual keyboard function by the item 1025.

In operation 1010, the processor 120 may display the activated designated object along with the plurality of keys within the display area of the virtual keyboard, at least a portion of which is superimposed on the user interface.

Although not illustrated in FIGS. 10A and 10B, the processor 120 may exclude the designated object from the virtual keyboard, or may display the designated object within the virtual keyboard in an inactive state on the basis of identification of deactivation of the visual keyboard function by the item 1025.

As described above, the electronic device 101 according to certain embodiments may configure whether to provide the image-based retrieval service through the virtual keyboard on the basis of user selection.

As described above, a method of operating an electronic device (for example, the electronic device 101) according to certain embodiments may include an operation of displaying an input unit capable of receiving a user input performed on an application being executed by the electronic device on the display, an operation of identifying one or more images stored in the memory or an external electronic device, based at least on the displaying, an operation of displaying at least some of the one or more images in association with the input unit, an operation of acquiring recognition information generated by recognizing at least a portion of content included in an image selected according to a designated input among at least some images, an operation of acquiring character information corresponding to the recognition information, based at least on the acquisition, and an operation of providing the character information to the application as at least a portion of the user input through the input unit.

According to certain embodiments, the operation of determining at least some images may include an operation of acquiring context information related to the electronic device and an operation of determining at least some of the one or more images, based at least on the context information. According to some embodiments, the method may further include an operation of acquiring other character information provided by the application through the input unit and an operation of storing the other character information as at least a portion of attribute information of the selected image.

According to certain embodiments, the method may further include an operation of storing the other character information as at least the portion of the attribute information of the selected image by inserting the other character information into metadata on the selected image.

According to certain embodiments, the method may further include an operation of acquiring resultant information processed using the character information through the application, and an operation of storing the resultant information as at least a portion of attribute information of the selected image.

According to certain embodiments, the method may further include an operation of transmitting information on the image selected according to the designated input among at least some images to a server and an operation of acquiring the recognition information on the content included in the image from the server.

According to certain embodiments, the operation of displaying at least some images in association with the input unit may include an operation of displaying the input unit, at least a portion of which is superimposed on the user interface of the application being executed by the electronic device and including a plurality of keys indicating a plurality of characters on the display and an operation of displaying at least some images switched from the plurality of keys within the input unit so as to display at least some images in association with the input unit.

As described above, an electronic device (for example, the electronic device 101) according to certain embodiments may include an operation of displaying a user interface of an application, an operation of displaying a designated object and a plurality of keys indicating a plurality of characters within a display area of a virtual keyboard, at least a portion of which is superimposed on a user interface in response to identification of input performed on a text-input portion included in the user interface, an operation of identifying one or more images related to an application among a plurality of applications stored in the electronic device, based at least on identification of the input performed on the designated object, and an operation of displaying one or more thumbnail images for representing the one or more images within the display area of the virtual keyboard, and the one or more thumbnail images may be usable to provide a retrieval service within the user interface using the one or more images.

According to certain embodiments, the method may further include, when executing the instructions, an operation of identifying an input of selecting one thumbnail image among the one or more thumbnail images, an operation of displaying at least one piece of text acquired by recognizing an image represented by the selected thumbnail image along with the one or more thumbnail images, and an operation of displaying the selected text within the text-input portion and displaying at least one piece of multimedia content related to the selected text within the user interface in response to identification of input of selecting one piece of text among the at least one piece of text. For example, the method may further include, when executing the instructions, an operation of providing a function related to the selected piece of multimedia content through the user interface in response to identification of input of selecting one piece of multimedia content among the at least one piece of multimedia content and an operation of storing at least one of the selected piece of multimedia content and the selected text in association with the image represented by the thumbnail image.

According to certain embodiments, the operation of identifying the one or more images may include an operation of identifying one or more images associated with one or more services provided by the application among the plurality of images so as to identify the one or more images related to the application. For example, the operation of identifying the one or more images may include an operation of identifying the one or more images associated with one or more services provided by the application among the plurality of images, based on information stored in the electronic device and associated with each of the plurality of images in response to identification of the input performed on the designated object, and the information associated with each of the plurality of images may include at least one piece of data acquired by recognizing content of each of the plurality of images, data on a source from which each of the plurality of images is acquired, and data on an application stored in the electronic device used to acquire each of the plurality of images, and may be stored in the electronic device in association with each of the plurality of images in response to acquisition of each of the plurality of images. For example, the information associated with each of the plurality of images may be included in each of the plurality of images. In another example, the information associated with each of the plurality of images may be configured with another file distinct from an image file for each of the plurality of images, and the image and the other file may be configured as one dataset.

According to certain embodiments, the data on the source may include data on at least one webpage that the electronic device accesses during a time interval identified based on the time at which each of the plurality of images is acquired, and the operation of identifying the one or more images may include an operation of identifying the one or more images associated with the one or more services provided by the application among the plurality of images, based on the data on the at least one webpage. For example, the data on the at least one webpage may be acquired by parsing a markup language file for the at least one webpage.

As described above, a method of operating an electronic device (for example, the electronic device 101) may include: an operation of displaying a first thumbnail image for representing a first image among a plurality of images stored in the electronic device along with a first user interface, based on reception of input performed on a designated object included in a virtual keyboard for at least a portion of a time during which the virtual keyboard is displayed along with the first user interface of a first application and providing content retrieved based at least on the first image within the first user interface, based on reception of at least one input performed on the first thumbnail image, and an operation of displaying a second thumbnail image for representing a second image, distinct from the first image, among the plurality of images along with a second user interface, based on reception of the input performed on the designated object included in the virtual keyboard for at least a portion of the time during which the virtual keyboard is displayed along with the second user interface of a second application, distinct from the first application, and providing other content distinct from the content retrieved based at least on the second image within the second user interface, based on reception of at least one input performed on the second thumbnail image.

According to certain embodiments, the second application may provide another service distinct from a service provided by the first application, the first image may be associated with the service provided by the first application, and the second image may be associated with the service provided by the second application.

According to certain embodiments, the content may be stored in association with the first image and the other content may be stored in association with the second image.

According to certain embodiments, the method may further include an operation of stopping display of a plurality of keys included in the virtual keyboard while the first thumbnail image is displayed and an operation of stopping display of the plurality of keys while the second thumbnail image is displayed.

An electronic device and a method thereof according to certain embodiments may provide an image retrieval service through a virtual keyboard independent from an application.

Effects which can be acquired by the disclosure are not limited to the above described effects, and other effects that have not been mentioned may be clearly understood by those skilled in the art from the following description.

Methods stated in claims and/or specifications according to certain embodiments may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to certain embodiments of the disclosure as defined by the appended claims and/or disclosed herein.

The programs (software modules or software) may be stored in non-volatile memories including a random access memory and a flash memory, a Read Only Memory (ROM), an Electrically Erasable Programmable Read Only Memory (EEPROM), a magnetic disc storage device, a Compact Disc-ROM (CD-ROM), Digital Versatile Discs (DVDs), or other type optical storage devices, or a magnetic cassette. Alternatively, any combination of some or all of the may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the above-described detailed embodiments of the disclosure, a component included in the disclosure is expressed in the singular or the plural according to a presented detailed embodiment. However, the singular form or plural form is selected for convenience of description suitable for the presented situation, and certain embodiments of the disclosure are not limited to a single element or multiple elements thereof. Further, either multiple elements expressed in the description may be configured into a single element or a single element in the description may be configured into multiple elements.

While the disclosure has been shown and described with reference to certain embodiments thereof, it will be understood by those skilled in the art that various changes in form and details may be made therein without departing from the scope of the disclosure. Therefore, the scope of the disclosure should not be defined as being limited to the embodiments, but should be defined by the appended claims and equivalents thereof.

What is claimed is:

1. An electronic device comprising:
a memory;
a display; and
at least one processor,
wherein the at least one processor is configured to:
display an input unit capable of receiving a user input to an application being executed by the electronic device on the display;
identify one or more images stored in the memory or an external electronic device, the one or more images related to the application;
display some of the one or more images in association with the input unit;
recognize at least a portion of content included in a selected image among thesome of the one or more images; and
provide character information to the application based on the recognized at least the portion of the content as a portion of the user input through the input unit.

2. The electronic device of claim 1, wherein the at least one processor is configured determine the some of the one or more images, based at least on context information.

3. The electronic device of claim 1, wherein the at least one processor is configured to identify other character information provided by the application through the input unit and store the other character information as at least a portion of attribute information of the selected image.

4. The electronic device of claim 3, wherein the at least one processor is configured to store the other character information as at least the portion of the attribute information of the selected image by inserting the other character information into metadata for the selected image.

5. The electronic device of claim 1, wherein the at least one processor is configured to acquire resultant information processed using the character information through the application, and store the resultant information as at least a portion of attribute information of the selected image.

6. The electronic device of claim 1, wherein recognize the at least the portion of content included in the selected image among the some of the one or more images includes transmitting the at least some of the one or more images to a server, receiving recognition information corresponding content included in the at least some of the one or more images from the server, and acquire the recognition information on the content included in the image selected according to a designated input.

7. The electronic device of claim 1, wherein the character information is changed according to a type of a service provided by the application being executed.

8. An electronic device comprising:
a memory storing instructions;
a display; and
at least one processor,
wherein the at least one processor is configured to, when executing the instructions:
display a user interface of an application,
display a designated object and a plurality of keys indicating a plurality of characters within a display area of a virtual keyboard, at least a portion of which is superimposed on a user interface in response to identification of an input performed on a text-input portion included in the user interface,
identify one or more images related to the application among a plurality of applications stored in the electronic device, based at least on identification of the input performed on the designated object, and
display one or more thumbnail images for representing the one or more images within the display area of the virtual keyboard, wherein selection of a selected one of the one or more thumbnail images causes a query based on the selected one of the one or or more thumbnail images.

9. The electronic device of claim 8, wherein the at least one processor is further configured to, when executing the instructions, identify an input selecting the selected one of the one or more thumbnail images, display text, acquired by recognizing an image represented by the the selected one of the one or more thumbnail images, display selected text within the text-input portion and display multimedia content related to the selected text within the user interface in response to selecting of the selected text.

10. The electronic device of claim 9, wherein the at least one processor when executing the instructions, provides a function related to a selected multimedia content through the user interface in response to selecting multimedia content and store the selected multimedia content and the selected text in association with the image represented by the thumbnail image.

11. The electronic device of claim 8, wherein the at least one processor when executing the instructions, identifies one or more images associated with one or more services provided by the application.

12. The electronic device of claim 11, wherein the at least one processor when executing the instructions, identifies the one or more images associated with one or more services provided by the application, based on information stored in the electronic device and associated with each of the one or more images in response to identification of the input performed on the designated object, and the information associated with each of the one or more images includes data acquired by recognizing content of each of the one or more images, data on a source from which each of the one or more images is acquired, and data on an application stored in the electronic device used to acquire each of the one or more images and is stored in the electronic device in association with each of the one or more images in response to acquisition of each of the one or more images.

13. The electronic device of claim 12, wherein the information associated with each of the one or more of images is included in each of the one or more images.

14. The electronic device of claim 12, wherein the information associated with each of the one or more images is configured in another file distinct from an image file for each of the one or more images, and the image and the another file are configured as one dataset.

15. The electronic device of claim 12, wherein the data on the source includes data on at least one webpage that the electronic device accesses during a time interval identified based on a time at which each of the one or more images is acquired, and the at least one processor is configured to, when executing the instructions, identify the one or more images associated with the one or more services provided by the application among the one or more images, based on the data on the at least one webpage.

16. The electronic device of claim 15, wherein the data on the at least one webpage is acquired by parsing a markup language file for the at least one webpage.

17. An electronic device comprising:
a memory storing instructions;
a display; and
at least one processor,
wherein the at least one processor is configured to:
display a first thumbnail image for representing a first image among a plurality of images stored in the electronic device along with a first user interface, based on reception of an input performed on a designated object included in a virtual keyboard for at least a portion of a time during which the virtual keyboard is displayed along with the first user interface of a first application;
provide content retrieved based at least on the first image within the first user interface, based on reception of at least one input performed on the first thumbnail image,
display a second thumbnail image for representing a second image distinct from the first image among the plurality of images along with a second user interface, based on reception of the input performed on the designated object included in the virtual keyboard for the at least the portion of the time during which the virtual keyboard is displayed along with the second user interface of a second application distinct from the first application; and
provide another content distinct from the content retrieved based at least on the second image within the second user interface, based on reception of at least one input performed on the second thumbnail image.

18. The electronic device of claim 17, wherein the second application provides another service distinct from a service provided by the first application, the first image is associated with the service provided by the first application, and the second image is associated with the service provided by the second application.

19. The electronic device of claim 17, wherein the content is stored in association with the first image and the another content is stored in association with the second image.

20. The electronic device of claim 17, wherein the at least one processor is further configured to stop displaying a plurality of keys included in the virtual keyboard while the first thumbnail image is displayed and stop displaying the plurality of keys while the second thumbnail image is displayed.
